(19) United States
(12) Patent Application Publication
(10) Pub. No.: US 2013/0120198 A1
(43) Pub. Date: May 16, 2013

(54) ANTENNA DEVICE

(71) Applicant: MURATA MANUFACTURING CO., LTD., Kyoto-fu (JP)

(72) Inventors: Yoshiro MAEDA, Nagaokakyo-shi (JP); Kazuhiro YAMAJI, Nagaokakyo-shi (JP)

(73) Assignee: MURATA MANUFACTURING CO., LTD., Kyoto-fu (JP)

(21) Appl. No.: 13/740,998

(22) Filed: Jan. 14, 2013

Related U.S. Application Data
(63) Continuation of application No. PCT/JP2011/055584, filed on Mar. 10, 2011.

(30) Foreign Application Priority Data
Jul. 16, 2010 (JP) 2010-162132

(51) Int. Cl. H01Q 9/04

(52) U.S. Cl. CPC H01Q 9/04
USPC 343/700 MS

(57) ABSTRACT

An antenna element having directionality in a zenith direction, which includes a first radiation electrode and a second radiation electrode which face each other across a slit on a cuboid dielectric block, is arranged closer to one of corners of a substrate and so as that a longer length direction thereof is aligned to one side of the substrate. A first end portion of the first radiation electrode is connected to a ground electrode of the substrate, and a first end portion of the second radiation electrode is directly connected to a feed portion of the substrate or through a capacitance. When the antenna element is to be mounted on a left corner of the substrate, a position of the slit on the dielectric block is shifted from a center of the dielectric block toward a center of an antenna element mounted side of the substrate.

### CROSS REFERENCE TO RELATED APPLICATIONS

The present application is a continuation of International Patent Application No. PCT/2011/055584 filed on Mar. 10, 2011, and claims priority to Japanese Patent Application No. 2010-162132 filed Jul. 16, 2010, the entire contents of each of these applications being incorporated herein by reference in their entirety.

### TECHNICAL FIELD

The technical field relates to an antenna device including an antenna element, in which a plurality of electrodes is formed on a cuboid dielectric block, and a substrate in which a ground electrode is formed on a base member.

### BACKGROUND

PCT International Application Publication No. WO2008/035526 (Patent Document 1) and Japanese Unexamined Patent Application Publication No. 2004-96209 (Patent Document 2) disclose antenna devices that are formed by mounting a surface-mount type antenna, in which a radiation electrode is formed on a dielectric block, on a substrate.

The antenna device of Patent Document 1 is an antenna device such that the surface-mount type antenna (antenna element) is mounted on a non-ground area of the substrate. One end of the radiation electrode of the antenna is connected to a ground while the other end is an open end, and includes an electrode portion in between a ground connection portion and the open end, which receives a capacitive power feed. A ground electrode is formed on the dielectric block to form an electrical connection with the open end of the radiation electrode through capacitive coupling.

The antenna device of Patent Document 2 is a diversity antenna device such that two chip antennas sharing a common electrode are arranged so as that each of ground electrodes of the chip antennas faces one side of a circuit board, and directions of their resonant currents to be excited on the circuit board are substantially orthogonal to each other in non-symmetrical fashion.

In the antenna device of Patent Document 1, antenna directionality is not considered in relation to an electrode structure. Thus, it is not for obtaining the directionality such as, for example, a zenith direction that is advantageous for GPS usage. In the antenna device of Patent Document 2, it is possible to control the directionality to some extent. However, such a control requires two antenna elements and a circuit for a diversity control.

FIG. 1 illustrates a perspective view of a typical λ/4 monopole type antenna device as a comparative example. FIG. 2 illustrates a perspective view of a typical capacitive feed type antenna device.

The antenna device illustrated in FIG. 1 includes an antenna element 101 in which a radiation electrode 11 is formed on a cuboid dielectric block 10, and a substrate 201 in which a ground electrode 21 and a feed terminal 22 are formed on a base member 20. One end of the radiation electrode 11 of the antenna element is electrically connected to the feed terminal 22 on the substrate, and the radiation electrode 11 receives a direct power feed.

The antenna device illustrated in FIG. 2 includes an antenna element 102 in which a radiation electrode 11 and a feed electrode 12 are formed on a cuboid dielectric block 10, and a substrate 202 in which a ground electrode 21 and a feed terminal 22 are formed on a base member 20. The feed electrode 12 of the antenna element is electrically connected to the feed terminal 22 on the substrate, and the radiation electrode 11 receives a capacitive power feed.

FIGS. 3A and 3B are diagrams illustrating the directionality of the antenna device illustrated in FIG. 1, and FIGS. 4A and 4B are diagrams illustrating the directionality of the antenna device illustrated in FIG. 2. FIGS. 3A and 4A are diagrams each illustrating an intensity distribution of a current (hereinafter, referred to as “substrate current”) flowing through the ground electrode of the substrate, where an arrow direction represents the direction of the current flowing through the ground electrode of the substrate, and a size and darkness of an arrow head represent the intensity of the current. Furthermore, FIGS. 3B and 4B are diagrams each illustrating an intensity distribution of electric field in a y-z plane (a plane of the substrate where the Z axis is the zenith direction) of the antenna device and the darkness represents the intensity of electric field. An imbalance in the darkness indicates the directionality in the y-z plane.

### SUMMARY

The present disclosure provides an antenna device that has the directionality in the zenith direction like a GPS antenna.

An antenna device according to an embodiment of the present disclosure includes an antenna element in which a plurality of electrodes is formed on a cuboid dielectric block and a substrate in which a ground electrode is formed on a base member. The plurality of electrodes includes at least a first radiation electrode and a second radiation electrode. A first end portion of the first radiation electrode is connected to the ground electrode of the substrate, and a first end portion of the second radiation electrode is directly connected to a feed portion of the substrate or through a capacitance. Second end portions of the first and second radiation electrodes face each other with a slit in between, where the slit has a preset gap. The antenna element is arranged closer to one of corners of the substrate such that a longer length direction thereof is aligned to one side of the substrate, and a position of the slit on the dielectric block is away from, or shifted from a center of the dielectric block toward a center of the one side of the substrate.

In a more specific embodiment, the substrate may include a ground opening portion, and the antenna element may be structured such that the antenna element is mounted on the ground opening portion.

In another more specific embodiment, the first radiation electrode may be formed from a first end surface to a top surface of the dielectric block, the second radiation electrode may connected to the ground electrode at the first end portion thereof, and formed from a second end surface to the top surface of the dielectric block. A feed electrode may be formed on the second end surface of the dielectric block so as that the capacitance exists between the feed electrode and the second radiation electrode, and the slit may be provided on the top surface of the dielectric block.

In yet another more specific embodiment, the first radiation electrode may be formed from a first end surface to a top surface of the dielectric block, the second radiation electrode may be connected to the feed portion at the first end portion thereof, and formed from a second end surface to the top surface of the dielectric block, and the slit may be provided on the top surface of the dielectric block.

### BRIEF DESCRIPTION OF DRAWINGS

FIG. 1 illustrates a perspective view of a typical λ/4 monopole type antenna device as a comparative example.

FIG. 2 illustrates a perspective view of a typical capacitive feed type antenna device as a comparative example.

FIGS. 3A and 3B are diagrams illustrating directionality of the antenna device illustrated in FIG. 1.

FIGS. 4A and 4B are diagrams illustrating directionality of the antenna device illustrated in FIG. 2.

FIG. 5 is a perspective view of an antenna device 311 according to a first exemplary embodiment.

FIG. 6 is an equivalent circuit diagram of the antenna device 311 illustrated in FIG. 5.

FIGS. 7A and 7B are diagrams illustrating directionality of the antenna device 311 according to the first embodiment.

FIG. 8 is a diagram illustrating a schematic directional pattern of the antenna device 311.

FIG. 9 is a diagram illustrating a relationship between a slit position and a mounting position of an antenna element on a substrate.

FIG. 10 is a perspective view of an antenna device 312 according to a second exemplary embodiment.

FIG. 11 is an equivalent circuit diagram of the antenna device 312 illustrated in FIG. 10.

FIG. 12 is a perspective view of an antenna device 313 according to a third exemplary embodiment.

FIG. 13 is an equivalent circuit diagram of the antenna device 313 illustrated in FIG. 12.

FIG. 14 is a perspective view of an antenna device 314 according to a fourth exemplary embodiment.

FIG. 15 is a perspective view of an antenna device 315 according to the fourth exemplary embodiment.

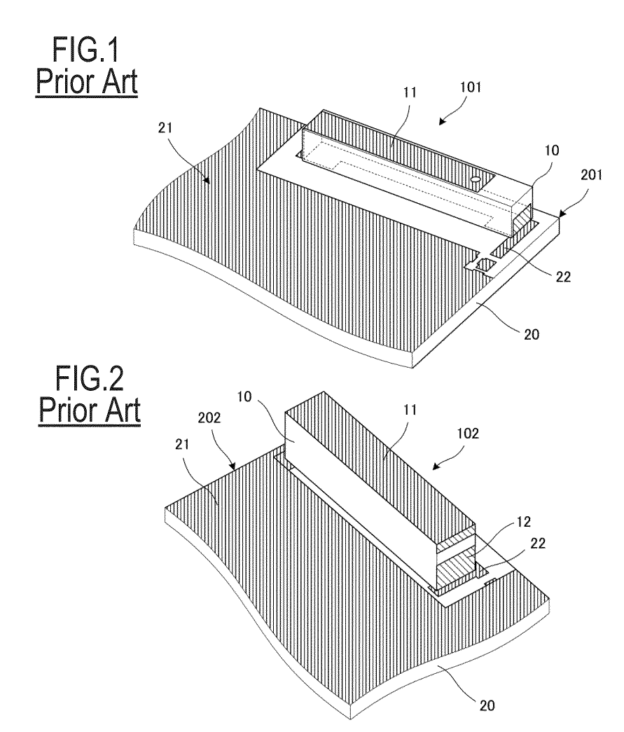

### DETAILED DESCRIPTION

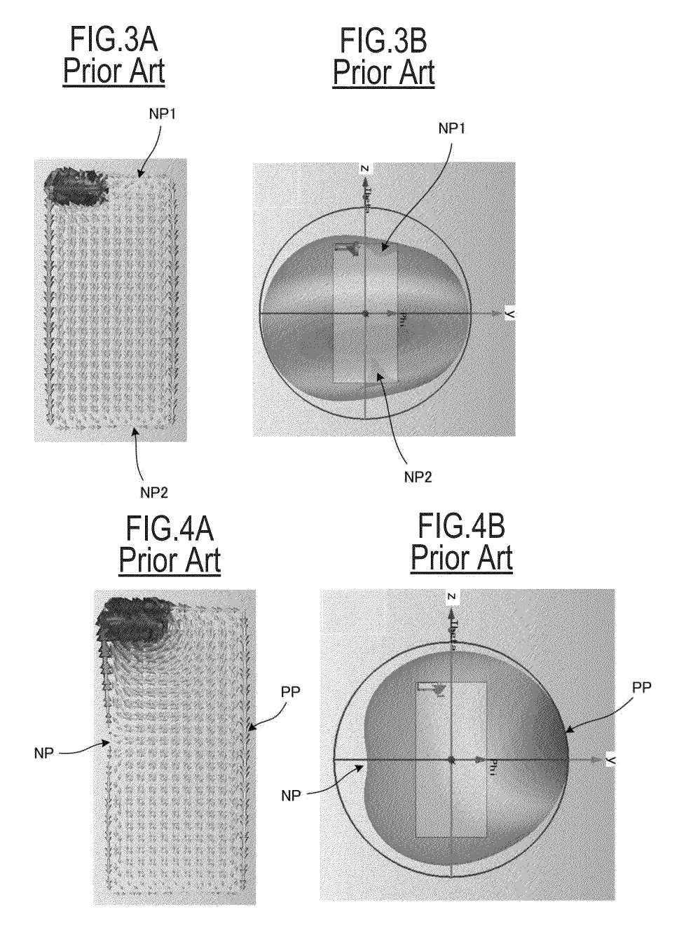

The inventors realized that in the typical λ/4 monopole type antenna device, as is clear from FIGS. 3A and 3B, null points NP1 and NP2 exist near the z-axis at symmetric positions with respect to the y-axis that serves as the axis of symmetry. Thus, the gain in the z direction is low, and a peak position rather exists in the −y direction.

Furthermore, in the capacitive feed type antenna device, as is clear from FIGS. 4A and 4B, a peak point PP and a null point NP exist in the y direction and the −y direction, respectively. Thus, the gain in the z direction is low. If the y direction of the antenna device were pointed to the zenith direction, a higher gain may be obtained in the actual zenith direction. However, the directionality is too sharp to obtain an ample gain in a lower elevation angle direction. Furthermore, when shapes of commonly-used communication devices are being considered, the antenna devices would not be directed in the zenith direction when being used. For example, for a portable phone device, a shorter side on which the antenna is placed faces to the zenith.

The above-described conventional antenna devices that are formed by mounting the surface-mount type antenna element on the substrate may not obtain higher gains over a wide range around the zenith direction (i.e., a wide elevation angle range from a low elevation angle to a high elevation angle).

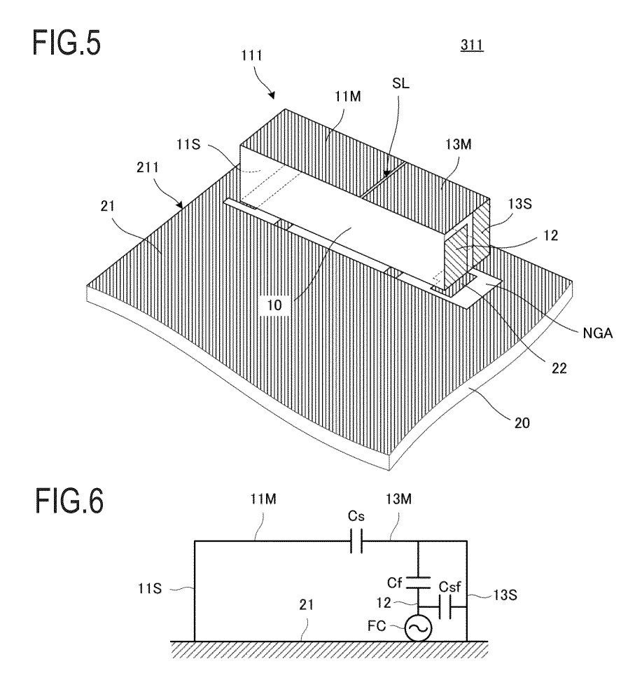

FIG. 5 is a perspective view of an antenna device 311 according to a first exemplary embodiment that can provide directionality in the zenith direction. The antenna device 311 illustrated in this drawing includes an antenna element 111 in which various electrodes are formed on a cuboid dielectric block 10, and a substrate 211 in which various electrodes are formed on a base member 20.

The dielectric block 10 has a rectangular parallelepiped shape. In a state illustrated in FIG. 5, a radiation electrode 11M that is part of a first radiation electrode and a radiation electrode 13M that is part of a second radiation electrode are formed on a top surface of the dielectric block 10. A feed electrode 12 and a radiation electrode 13S that is part of the second radiation electrode are formed on a right front side end surface of the dielectric block 10. Furthermore, a radiation electrode 11S that is part of the first radiation electrode is formed on a left back side end surface of the dielectric block 10. The radiation electrodes 11S and 11M are electrically connected to each other at a ridge or edge of the dielectric block 10. Similarly, the radiation electrode 13S and the radiation electrode 13M are electrically connected to each other at a ridge or edge of the dielectric block 10. Top portions, or end portions of the radiation electrode 11M and the radiation electrode 13M, or respective ends thereof, face each other with a slit SL in between. The slit SL has a preset gap.

Mounting electrodes, which are electrically connected to the respective ones of the radiation electrode 11S, the radiation electrode 13S, and the feed electrode 12, are formed on a bottom surface of the dielectric block 10 (i.e., a mounting surface to be mounted on the substrate 211).

A ground electrode 21 is formed on the base member 20. However, in a ground opening portion NGA (non-ground area), the ground electrode 21 is formed on neither side of the base member 20. That is, the ground opening portion NGA is electrically open. A feed terminal 22 is formed on the ground opening portion NGA. FIG. 5 provides a simple illustration. A feed circuit is provided (connected) between the feed terminal 22 and the ground electrode 21.

In a state where the antenna element 111 is being mounted on the foregoing ground opening portion NGA, the mounting electrodes, which are electrically connecting to the radiation electrodes 11S and 13S, electrically connect to the ground electrode 21 on the substrate 211. Furthermore, the mounting electrode, which is electrically connecting to the feed electrode 12, electrically connects to the feed terminal 22 on the substrate 211.

The radiation electrodes 13S, 13M and the feed electrode 12 of the antenna element 111 are arranged in close proximity, and thus, there is a capacitance therebetween. Furthermore, there is a capacitance in a slit SL portion across which the top portions, or end portions of the radiation electrode 11M and the radiation electrode 13M face each other.

FIG. 6 is an equivalent circuit diagram of the antenna device 311 illustrated in FIG. 5. Like reference numerals denote like elements to those illustrated in FIG. 5. In FIG. 6, a capacitor Cs is the capacitance existing in the slit SL portion illustrated in FIG. 5. A capacitor Cf is the capacitance existing between the radiation electrode 13M and the feed electrode 12 illustrated in FIG. 5. A capacitor Csf is the capacitance existing between the feed electrode 12 and the radiation electrode 13S.

As described above, a signal of the feed circuit FC is fed to the radiation electrode 13M through the capacitors Cf and Csf. Furthermore, the first radiation electrode 11M, 11S receives the power feed from the second radiation electrode 13M, 13S through the capacitor Cs.

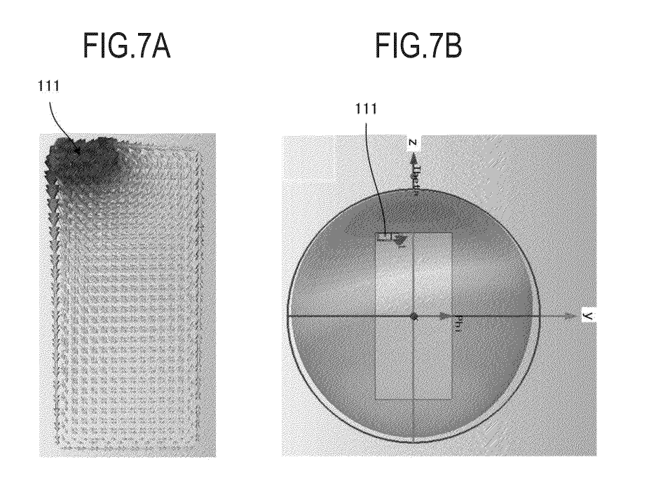

FIGS. 7A and 7B are diagrams illustrating the directionality of the antenna device 311 according to the first exemplary embodiment. FIG. 7A is a diagram illustrating an intensity distribution of the substrate current, where the arrow direction represents the direction of the current flowing through the ground electrode of the substrate, and the size and darkness of an arrow head represent the intensity of the current. Furthermore, FIG. 7B is a diagram illustrating an intensity distribution of the electric field in the y-z plane (i.e., the plane of the substrate where the Z axis is the zenith direction) of the antenna device, and the darkness represents the intensity of the electric field.

In the antenna device 311, as is clear from FIG. 7A, there isn't any point where reversed phase currents cancel out each other. That is, no null point exists. Furthermore, as illustrated in FIG. 7A, in general, the current intensity is higher as its position becomes closer to the top. This is because that the slit SL portion of the antenna element 111 becomes a maximum current point, and that the current in an antenna element mounted side is being balanced by a position of the slit SL. In this example, the antenna element 111 is mounted on a left upper corner of the substrate. The position of the slit SL on the dielectric block 10 is shifted from a center of the dielectric block toward a center of the antenna element mounted side. According to such an arrangement, the maximum current point moves toward the center of the antenna element mounted side of the substrate, and the total current intensity in the antenna element mounted side becomes higher.

Since the current intensity is higher in the antenna element mounted side (one of the shorter sides of the substrate, which is defined as the zenith direction) as described above, the gain is higher in an upper half than a lower half in general, and the directionality in which a peak position exists in the zenith direction may be obtained, as illustrated in FIG. 7B.

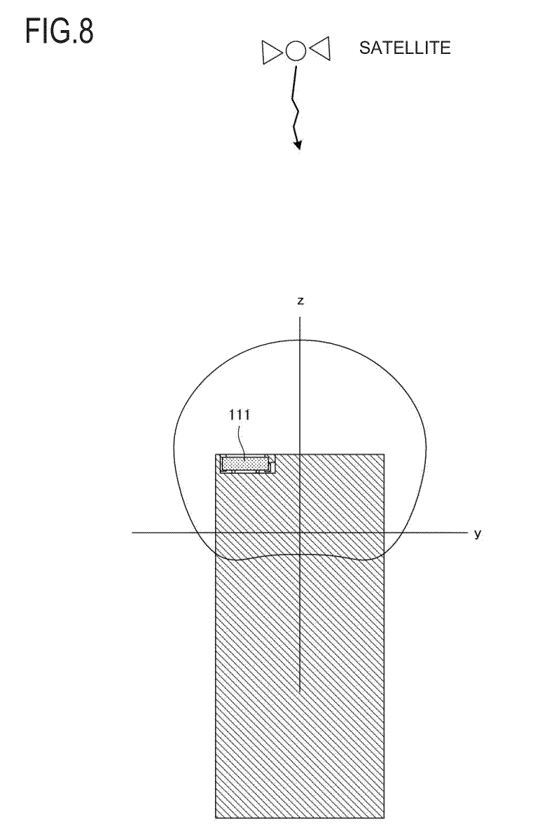

FIG. 8 is a diagram illustrating a schematic directional pattern of the antenna device 311. As described above, a higher gain may be obtained over a wide range around the zenith direction (i.e., a wide elevation angle range from a low elevation angle to a high elevation angle).

FIG. 9 is a diagram illustrating a relationship between the position of the slit SL and the mounting position of the antenna element on the substrate. FIG. 9A is an example of the case described above, where the antenna element 111 is mounted on the left upper corner of the substrate 211. In this case, the position of the slit SL on the dielectric block may be shifted from the center of the dielectric block toward the center (i.e., a position direction indicated by a dashed-dotted line in the drawing) of the antenna element mounted side of the substrate. FIG. 9B is an example of a case where an antenna element 111R is mounted on the right corner of a substrate 211R. In this case, the position of the slit SL on the dielectric block may be shifted from the center of the dielectric block toward the center (i.e., a position direction indicated by a dashed-dotted line in the drawing) of the antenna element mounted side of the substrate.

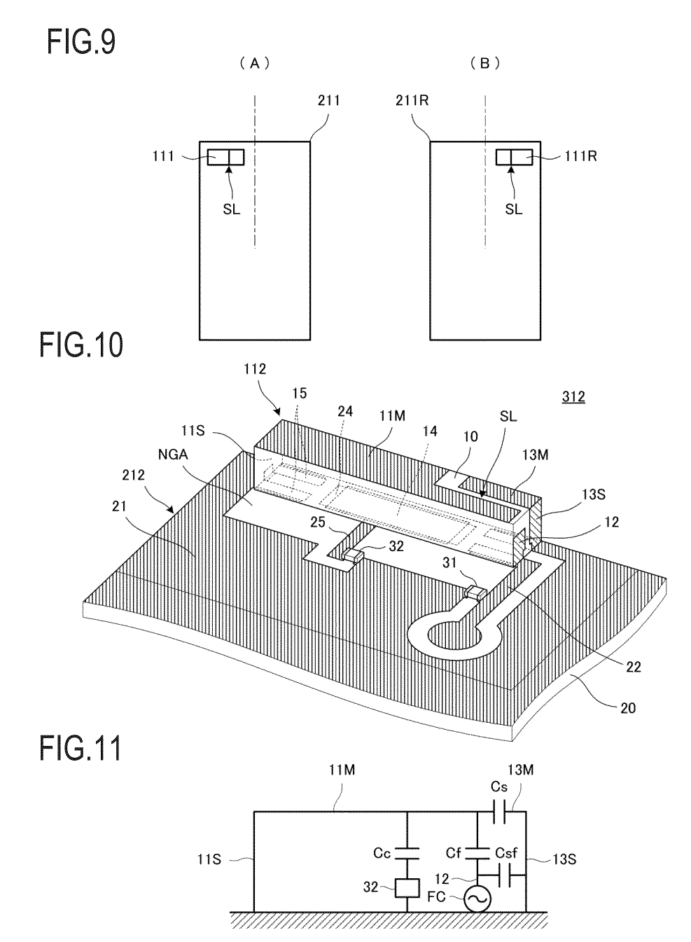

FIG. 10 is a perspective view of an antenna device 312 according to a second exemplary embodiment. The antenna device 312 illustrated in this drawing includes an antenna element 112 in which various electrodes are formed on a cuboid dielectric block 10, and a substrate 212 in which various electrodes are formed on a base member 20.

The dielectric block 10 has a rectangular parallelepiped shape. In a state illustrated in FIG. 10, a radiation electrode 11M that is part of a first radiation electrode and a radiation electrode 13M that is part of a second radiation electrode are formed on a top surface of the dielectric block 10. A feed electrode 12 and a radiation electrode 13S that is part of the second radiation electrode are formed on a right front side end surface of the dielectric block 10. Furthermore, a radiation electrode 11S that is part of the first radiation electrode is formed on a left back side end surface of the dielectric block 10. The radiation electrodes 11S and 11M are electrically connected to each other at a ridge or edge of the dielectric block 10. Similarly, the radiation electrode 13S and the radiation electrode 13M are electrically connected to each other at a ridge or edge of the dielectric block 10. Top portions, or end portions of the radiation electrode 11M and the radiation electrode 13M are arranged in close proximity with a slit SL in between. The slit SL has a preset gap along a longer direction of the radiation electrode 11M and the radiation electrode 13M.

A capacitance electrode 14 is formed on a bottom surface of the dielectric block 10 (i.e., on a mounting surface to be mounted on the substrate 212). Furthermore, mounting electrodes, which are electrically connected to the respective ones of the radiation electrode 11S, the radiation electrode 13S, and the feed electrode 12, are also formed. The mounting electrode 15 that electrically connects to the radiation electrode 11S is divided into two portions, and is connected to the ground electrode 21 of the substrate. Arranging the respective mounting electrodes symmetrically as described above enables to improve self-alignment capability at the time of soldering and mounting position accuracy of the antenna element 112 relative to the substrate 212.

A ground electrode 21 is formed on the base member 20. However, in a ground opening portion NGA, the ground electrode 21 is formed on neither side of the base member 20. That is, the ground opening portion NGA is electrically open. A feed terminal 22, a capacitance electrode terminal 24, and a lead terminal 25 are formed on the ground opening portion NGA. A feed circuit is provided between the feed terminal 22 and the ground electrode 21.

If necessary, a matching element 31 is provided to connect the feed terminal 22 and the ground electrode 21, as illustrated in FIG. 10.

In a state where the antenna element 112 is being mounted on the foregoing ground opening portion NGA, the mounting electrodes, which are electrically connecting to the radiation electrodes 11S and 13S, electrically connect to the ground electrode 21 on the substrate 212. Furthermore, the mounting electrode, which is electrically connecting to the feed electrode 12, electrically connects to the feed terminal 22 on the substrate 212.

The feed electrode 12 and the second radiation electrode 13S, 13M of the antenna element 112 are arranged in close proximity, and thus, there is a capacitance therebetween. Furthermore, there is a capacitance in a slit SL portion across which the top portions, or end portions of the radiation electrode 11M and the radiation electrode 13M face each other.

If necessary, a resonance frequency adjustment element 32 is mounted between the lead terminal 25 and the ground electrode 21.

FIG. 11 is an equivalent circuit diagram of the antenna device 312 illustrated in FIG. 10. Like reference numerals denote like elements to those illustrated in FIG. 10. In FIG. 11, a capacitor Cs is the capacitance existing in the slit SL portion illustrated in FIG. 10. A capacitor Cf is the capacitance existing between the radiation electrode 11M and the feed electrode 12 illustrated in FIG. 10. A capacitor Cc is the capacitance existing between the radiation electrode 11M and the capacitance electrode 14. A capacitor Csf is the capacitance existing between the feed electrode 12 and the radiation electrode 13S.

As described above, a signal of the feed circuit FC is fed to the radiation electrode 11M through the capacitors Cf and Csf and the slit SL of the radiation electrode 13M. Furthermore, the second radiation electrode 13M, 13S receives the power feed from the radiation electrode 11M through the capacitor Cs. Furthermore, a resonance frequency of the antenna device is set to a preset value by the capacitor Cc and the resonance frequency adjustment element 32.

In an example illustrated in FIG. 10, the antenna element 112 is mounted on the left upper corner of the substrate. Therefore, the slit SL is shifted from the center of the dielectric block 10 toward the right hand side. In a case where the antenna element is to be mounted on the right upper corner of the substrate, the antenna element, in which the slit is shifted from the center of the dielectric block toward the left hand side, may be mounted.

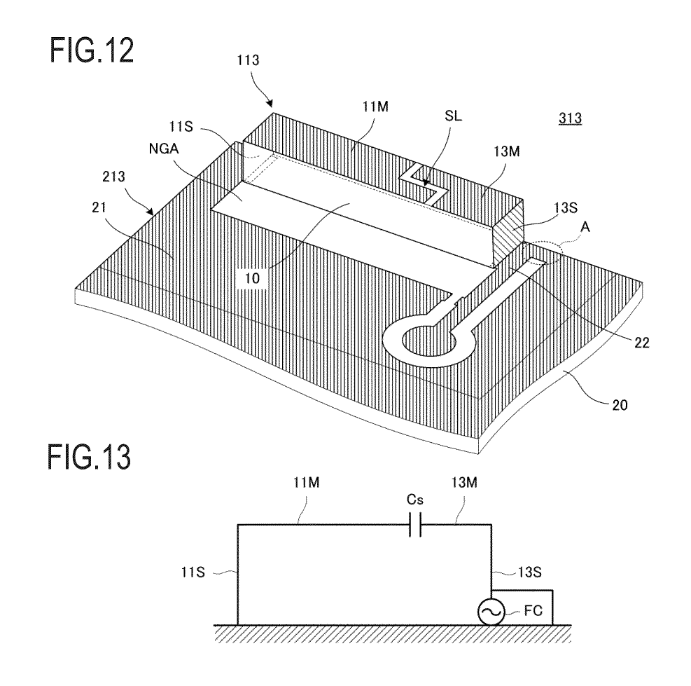

FIG. 12 is a perspective view of an antenna device 313 according to a third exemplary embodiment. The antenna device 313 illustrated in this drawing includes an antenna element 113 in which various electrodes are formed on a cuboid dielectric block 10, and a substrate 213 in which various electrodes are formed on a base member 20.

In a state illustrated in FIG. 12, a radiation electrode 11M that is part of a first radiation electrode and a radiation electrode 13M that is part of a second radiation electrode are formed on a top surface of the dielectric block 10. A radiation electrode 13S that is part of the second radiation electrode is formed on a right front side end surface of the dielectric block 10. Furthermore, a radiation electrode 11S that is part of the first radiation electrode is formed on a left back side end surface of the dielectric block 10. The radiation electrodes 11S and the radiation electrode 11M are electrically connected to each other at a ridge or edge of the dielectric block 10. Similarly, the radiation electrode 13S and the radiation electrode 13M are electrically connected to each other at a ridge or edge of the dielectric block 10. Top portions, or end portions of the radiation electrode 11M and the radiation electrode 13M are arranged in close proximity with a slit SL in between. The shape of the slit SL is not limited to a right-reverse-curve shape. The slit SL may have a straight line slit shape when there is a large enough capacitance as is a case where the antenna has a wide width.

A ground electrode 21 is formed on the base member 20. However, in a ground opening portion NGA, the ground electrode 21 is formed on neither side of the base member 20. That is, the ground opening portion NGA is electrically open. A feed terminal 22 is formed on the ground opening portion NGA. A feed circuit is provided between the feed terminal 22 and the ground electrode 21. Here, as illustrated in FIG. 12, the feed terminal 22 and the ground electrode 21 are directly connected to each other at an “A” portion.

In a state where the antenna element 113 is being mounted on the foregoing ground opening portion NGA, the radiation electrode 11S electrically connects to the ground electrode 21 on the substrate 213. The radiation electrode 13S electrically connects to the feed terminal 22 on the substrate 213.

There is a capacitance in a slit SL portion across which the top portions, or end portions of the radiation electrodes 11M and 13M of the antenna element 113 face each other.

FIG. 13 is an equivalent circuit diagram of the antenna device 313 illustrated in FIG. 12. Like reference numerals denote like elements to those illustrated in FIG. 12. In FIG. 13, a capacitor Cs is the capacitance existing in the slit SL portion illustrated in FIG. 12. A signal of the feed circuit FC is directly fed to the radiation electrode 13S.

Even in the case with the direct power feed as described above, the current flows along a path such that the feed terminal 22→the second radiation electrode 13S, 13M→the first radiation electrode 11M, 11S→the ground electrode 21. Thus, as is the case with the capacitive power feed, the current flows to the ground electrode 21 of the substrate. Although the power feeding methods are different, there is no change in the intensity distribution of the current. Thus, not only the capacitive power feed can be used, as described above, but also the direct power feed may be employed.

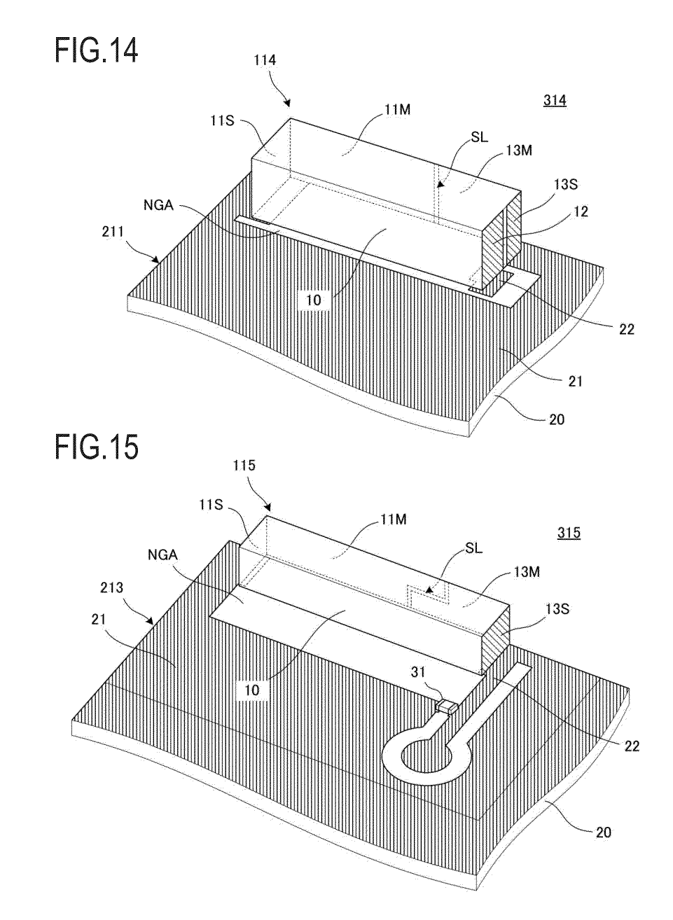

FIG. 14 and FIG. 15 are perspective views of two types of antenna device, antenna devices 314 and 315, according to a fourth exemplary embodiment.

The antenna device 314 illustrated in FIG. 14 includes an antenna element 114 in which various electrodes are formed on a cuboid dielectric block 10, and a substrate 211 in which various electrodes are formed on a base member 20. In a state illustrated in FIG. 14, a radiation electrode 11M that is part of a first radiation electrode and 13M that is part of a second radiation electrode are formed on a right back side surface of the dielectric block 10. A feed electrode 12 and a radiation electrode 13S that is part of the second radiation electrode are formed on a right front side end surface of the dielectric block 10. Furthermore, a radiation electrode 11S that is part of the first radiation electrode is formed on a left back side end surface of the dielectric block 10. The radiation electrodes 11S and the radiation electrode 11M are electrically connected to each other at a ridge or edge of the dielectric block 10. Similarly, the radiation electrode 13S and the radiation electrode 13M are electrically connected to each other at a ridge or edge of the dielectric block 10. Top portions, or end potions of the radiation electrode 11M and the radiation electrode 13M face each other with a slit SL in between. The slit SL has a preset gap. The remaining structure is similar to that of the antenna device illustrated in FIG. 5 of the first exemplary embodiment.

The antenna device 315 illustrated in FIG. 15 includes an antenna element 115 in which various electrodes are formed on a cuboid dielectric block 10, and a substrate 213 in which various electrodes are formed on a base member 20. In a state illustrated in FIG. 15, radiation electrodes 11M, 13M are formed on a right back side surface of the dielectric block 10. A radiation electrode 13S is formed on a right front side end surface of the dielectric block 10. Furthermore, a radiation electrode 11S is formed on a left back side end surface of the dielectric block 10. The radiation electrodes 11S and the radiation electrode 11M are electrically connected to each other at a ridge or edge of the dielectric block 10. Similarly, the radiation electrode 13S and the radiation electrode 13M are electrically connected to each other at a ridge or edge of the dielectric block 10. Top portions of the radiation electrode 11M and the radiation electrode 13M are arranged in close proximity with a right-reverse-curve-shaped slit SL in between. The remaining structure is similar to that of the antenna device illustrated in FIG. 12 of the third exemplary embodiment.

As described above, even when the antenna element, in which the radiation electrodes and the slit are formed on a surface perpendicular to the ground electrode 21 of the substrate, is mounted, the current that is similar to the cases with the antenna devices described in the first to third exemplary embodiments flows through the ground electrode 21. In other words, since the current flowing through the ground electrode of the substrate is dominant, a difference in the current intensity distribution is small when the case where the slit is provided on a surface that becomes the zenith side and the case where the slit is provided on a side surface are compared. Accordingly, it is also applicable to an antenna device on which an antenna element, in which the radiation electrodes and the slit are formed on a surface perpendicular to the ground electrode of the substrate, is mounted.

It should be noted that the present disclosure may also be applicable to an antenna device in which a ground electrode is formed on a back surface of an antenna element mounting position of the substrate. In such a type of antenna device, a ground current flows along an inner circumference of the ground opening portion on the mounting surface of the substrate, and the radiation by that current is suppressed by the ground electrode on the back surface. However, the intensity distribution of a substrate current exhibits a tendency similar to that of the type in which the antenna element is mounted on the ground opening portion. Thus, the directionality may be maintained in the zenith direction.

In embodiments according to the present disclosure, an antenna device has directionality in the zenith direction, which is advantageous for use in receiving satellite signals, as is the case with a GPS antenna.

That which is claimed is:

1. An antenna device comprising an antenna element in which a plurality of electrodes is formed on a cuboid dielectric block and a substrate in which a ground electrode is formed on a base member, wherein
the plurality of electrodes includes at least a first radiation electrode and a second radiation electrode,
a first end portion of the first radiation electrode is connected to the ground electrode of the substrate,
a first end portion of the second radiation electrode is directly connected to a feed portion of the substrate or through a capacitance,
second end portions of the first and second radiation electrodes face each other with a slit in between, the slit having a preset gap,
the antenna element is arranged closer to one of corners of the substrate and such that a longer length direction thereof is aligned to one side of the substrate, and
a position of the slit on the dielectric block is shifted from a center of the dielectric block toward a center of the one side of the substrate.

2. The antenna device according to claim 1, further comprising:
a ground opening portion in the substrate,
wherein the antenna element is mounted on the ground opening portion.

3. The antenna device according to claim 1, wherein
the first radiation electrode is formed from a first end surface to a top surface of the dielectric block,
the second radiation electrode is connected to the ground electrode at the first end portion thereof, and formed from a second end surface to the top surface of the dielectric block,
a feed electrode is formed on the second end surface of the dielectric block so as that the capacitance exists between the feed electrode and the second radiation electrode, and
the slit is provided on the top surface of the dielectric block.

4. The antenna device according to claim 1, wherein
the first radiation electrode is formed from a first end surface to a top surface of the dielectric block,
the second radiation electrode is connected to the ground electrode at the first end portion thereof, and formed from a second end surface to the top surface of the dielectric block,
a feed electrode is formed on the second end surface of the dielectric block so as that the capacitance exists between the feed electrode and the second radiation electrode, and
the slit is provided on the top surface of the dielectric block.

5. The antenna device according to claim 1, wherein
the first radiation electrode is formed from a first end surface to a top surface of the dielectric block,
the second radiation electrode is connected to the feed portion at the first end portion thereof, and formed from a second end surface to the top surface of the dielectric block, and
the slit is provided on the top surface of the dielectric block.

6. The antenna device according to claim 2, wherein
the first radiation electrode is formed from a first end surface to a top surface of the dielectric block,
the second radiation electrode is connected to the feed portion at the first end portion thereof, and formed from a second end surface to the top surface of the dielectric block, and
the slit is provided on the top surface of the dielectric block.
